(19) United States
(12) Patent Application Publication
(10) Pub. No.: US 2008/0025300 A1
(43) Pub. Date: Jan. 31, 2008

(54) Method and/or apparatus for enabling voice packet redundancy

(75) Inventors: David Alston Lide, Rockville, MD (US); Praphul Chandra, Bangalore (IN); Samant Kumar, Germantown, MD (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/495,688

(22) Filed: Jul. 31, 2006

(51) Int. Cl. H04L 12/56

(52) U.S. Cl. 370/389; 370/401

(57) ABSTRACT

A subscriber device capable of Voice over Internet Protocol (VoIP) communication via a wireless connection with an 802.11 access point to an Internet Protocol (IP) based network includes a codec for encoding a signal into a Real Time Protocol (RTP) packet and a controller for controlling a bit-rate at which the codec encodes the signal. The codec encodes the signal at a first bit-rate during normal transmissions and encodes the signal at a second bit-rate lower than the first bit-rate upon occurrence of a predetermined triggering event.

### TECHNICAL FIELD

The technical field relates generally to apparatus and methods for communication over a communication network and, particularly, to apparatus and methods for communication over 802.11 wireless local area networks.

### BACKGROUND

A wireless local area network (WLAN) conventionally configured according to the Institute of Electrical and Electronics Engineers (IEEE) 802.11 standard (hereafter “802.11”) enables wireless voice/data communication in which subscriber devices may be in wireless communication with another subscriber device via an 802.11 wireless access point (WAP). The WAP has a connection with a wired network, such as an Internet Protocol (IP) based network. Typically, the subscriber device will encode voice or data into packets to send to, and decode packets received from, the WAP into voice or data signals. A service area defined by a single WAP is limited by poor radio link quality conditions, such as, for example, interference due to microwave ovens or radio technologies in the unlicensed 2.4 GHz band, that can cause packet loss. A plurality of WAPS can be linked together to form a larger wireless network that permits roaming. However, the roaming condition itself may also lead to packet loss.

Conventional approaches to limiting packet loss have involved engineering the radio network to reduce poor reception cases and to minimize roaming times. However, such approaches lead to a dependency on WAP and security server response times to minimize handover time as well as an increase in power usage for updating the scan table to minimize time spent “in limbo” before deciding to roam.

### SUMMARY

Accordingly, one or more embodiments of the present invention provide a subscriber device capable of Voice over Internet Protocol (VoIP) communication via a wireless connection with an access point to an 802.11 network in a cost effective manner that minimizes network complexity. The subscriber device comprises a codec for encoding a voice signal into Real Time Protocol (RTP) packets and a controller for controlling a bit-rate at which the codec encodes the voice signal. The codec encodes the voice signal at a first bit-rate during normal transmissions and encodes the voice signal at a second bit-rate lower than the first bit-rate upon occurrence of a predetermined triggering event.

One or more embodiments of the present invention also provide a method of providing Voice over Internet Protocol (VoIP) communication over a wireless communication link. The method includes encoding a voice signal into packets at a first bit-rate during normal transmissions; if poor link quality exists, detecting occurrence of a predetermined triggering event associated with the poor link quality; and encoding the voice signal into packets at a second bit-rate lower than the first bit-rate upon the detecting of the occurrence of the predetermined triggering event associated with the poor link quality.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the present invention.

FIG. 1 is a block diagram of an exemplary subscriber device;

FIG. 2 is a flow diagram illustrating exemplary operation of the subscriber device when encoding a voice signal into a packet for transmission;

FIG. 3 is a flow diagram illustrating exemplary operation of the subscriber device when decoding a packet into a voice signal; and

FIG. 4 is a timing diagram illustrating exemplary communication of the subscriber device with other network components.

### DETAILED DESCRIPTION

In overview, the present disclosure concerns subscriber devices performing wireless communication via one or more 802.11 wireless access points that are connected to a communication network. The subscriber device may be any device capable of performing voice and/or data communication. More particularly, various inventive concepts and principles are embodied in systems, apparatus, and methods therein for providing a the subscriber device with a codec for encoding voice signal/data into Real Time Protocol (RTP) packets and a controller for controlling a bit-rate at which the codec encodes the voice signal/data.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefor, and/or application specific ICs, or a combination thereof. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

Referring to FIG. 1, an exemplary subscriber device 100 capable of Voice over Internet Protocol (VoIP) communication over a communication network, such as the Internet or any other Internet Protocol (IP) based network, via a wireless connection with an 802.11 wireless access point (WIP) will be described. The subscriber device 100 includes a host application 10 for performing protocol related functions such as, VoIP call signaling, user interface control, and a device driver. The host application 10 may be an application specific processor or a software program installed on a processor. The host application 10 also interacts with memory elements and a wireless local area network (WLAN) subsystem 18 described later.

The subscriber device 100 further includes a digital signal processor (DSP) 12 for interacting with voice functions such as a speaker and a microphone and for performing various other real time activities. The DSP 12 includes a controller 14 and a codec 16 controlled by the controller 14. Although the controller 14 and the codec 16 are shown as separate entities, they are both preferably implemented solely by the DSP 12. That is, they are preferably implemented as software instructions or hardware logic on the DSP 12.

The codec 16 encodes a voice signal or data into RTP packets for transmission and decodes received RTP packets into a voice signal or data. The controller 14 controls a bit-rate at which the codec 16 encodes the voice signal or decodes the RTP packets. Preferably, the controller 14 controls the codec 16 to encode/decode voice signal and/or data at a first bit-rate during normal transmissions and to encode/decode the voice signal and/or data at a second bit-rate lower than the first bit-rate upon occurrence of a predetermined triggering event. Further, upon occurrence of the predetermined triggering event, the controller 14 may control the codec 16 to encode redundancies, which are previously encoded voice signal or data, into a redundancy packet. This will be discussed in more detail later.

The subscriber device 100 further includes the WLAN subsystem 18 for handling transmission protocols on the wireless network, and for generally providing the wireless connection (or wireless link) with the WAP. The WLAN subsystem 18 is preferably a media access control (MAC) sublayer element and can be, for example, an 802.11 network interface card embodied in a peripheral device that is connected to the host application 10 to receive the encoded packets for transmission from the DSP 12. The subscriber device 100 further includes memory sources such as a static dynamic random access memory (SDRAM) 20 and a flash memory 22 connected to the WLAN subsystem 18 and used for temporary packet storage. For example, packets containing previously encoded voice signal or data may be stored in these memory sources.

As mentioned above, the controller 14 changes the encoding bit-rate for the codec 16 upon occurrence of the predetermined triggering event. The predetermined triggering event may be the WLAN subsystem 18 detecting that a received signal strength indication (RSSI) has fallen below a predetermined RSSI level or that a beacon from the WAP has been missed, or that a particular RTP packet has been retransmitted a predetermined number of times. However, in general, the triggering event may be any condition that causes a poor link condition. In such a case, the WLAN subsystem 18 can send a signal indicative of a poor link condition to the host application 10. The host application 10 will then send a command to the DSP 12 (specifically, the controller 14) to change the encoding bit-rate from the first bit-rate to the second bit-rate.

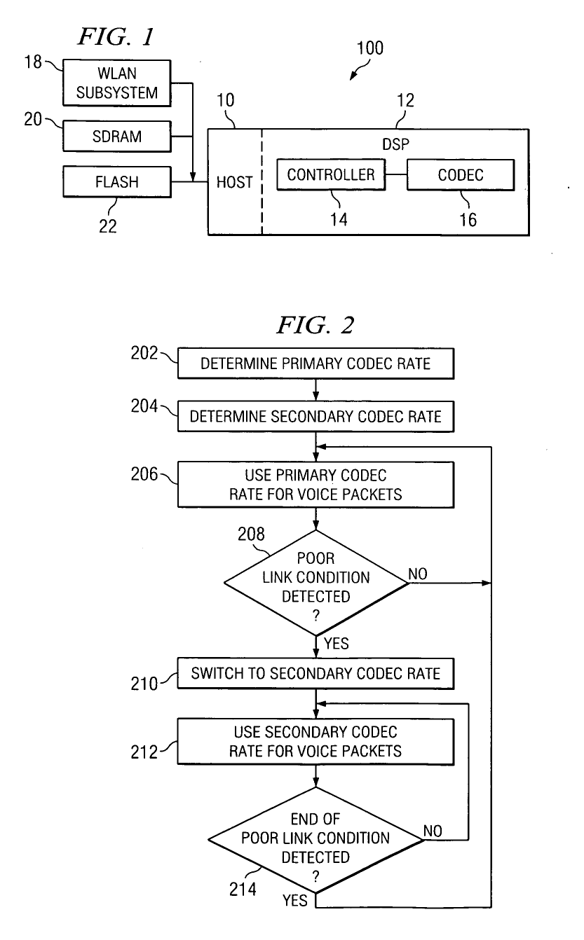

Referring to FIG. 2, an exemplary operation of the subscriber device 100 will be described in a scenario in which the subscriber device 100 encodes a voice signal into RTP packets to be sent over an IP based network via a wireless connection with the 802.11 WAP.

At 202, the subscriber device 100 determines a primary codec rate to be used for encoding the voice signal. The primary codec rate will be the first bit-rate at which the codec 16 encodes the voice signal into RTP voice packets during normal transmissions. The byte size of each of the RTP voice packets will depend on the codec used for encoding. For example, for a G711 codec at a voice packetization period of 20 ms, each RTP voice packet may be approximately 160 bytes. At 204, the subscriber device 100 determines a secondary codec rate to be used for encoding the voice signal into the RTP voice packets. The secondary codec rate will be the second bit-rate, which is lower than the first bit-rate, at which the codec 16 encodes the voice signal upon occurrence of the predetermined triggering event. The bit-rates of the primary and secondary codec rates are specified by the codec type. Exemplary codec types will be discussed in more detail below.

Because the secondary codec rate is lower than the first bit-rate, voice signals from one or more previous voice packets (redundancy) can be encoded within one RTP voice packet. That is, a redundancy packet can be generated that includes a portion of voice signal from one or more previous packet transmissions (redundancy) that is encoded at the second bit-rate. The redundancy packet may also include current voice signal encoded at the second bit-rate. However, the redundancy packet should have a packet length or bit length substantially equal to the packet length of each of the voice packets encoded at the first bit-rate, to reduce the potential occurrence of a negative feedback loop, and to keep within any pre-negotiated traffic rate (e.g., via 802.11 Traffic Specifications). For example, for G711 codec, the redundancy packet should have a packet length of approximately 160 bytes. Therefore, the number of previous packets (or voice signals from previous packets) will be limited by the number of spare bits available in a voice packet permitted by the secondary codec rate.

The primary and secondary codec rates, voice packet size, redundancy, as well as a forward error correction (FEC) technique are preferably determined during initial call negotiation and transmitted to the receiving party.

After the initial call negotiation, at 206, the subscriber device 100 will use the primary codec rate for encoding voice signals (voice speech) into RTP voice packets. Particularly, the controller 14 controls the codec 16 to encode the voice signals at the primary codec rate. The encoded voice packets are transmitted to the WAP by the WLAN subsystem 18.

At 208, the subscriber device 100 determines if a poor link condition exists. Particularly, in this scenario, a poor link condition corresponds to the occurrence of the predetermined triggering event mentioned briefly above. A poor link condition may be detected by, for example, a RSSI measured by the WLAN subsystem 18 falling below a predetermined RSSI level, the WLAN subsystem 18 missing a beacon from the WAP, or the WLAN subsystem 18 unsuccessfully transmitting a predetermined number of voice packets. Upon detecting the poor link condition, the WLAN subsystem 18 transmits a signal indicative of the occurrence of the predetermined triggering event (poor link condition) to the host application 10, which transmits it to the controller 14 so that the codec rate can be switched from the primary codec to the secondary codec.

If, at 208, no poor link condition is detected, the routine returns to 206, and the subscriber device 100 continues to use the primary codec rate. If, at 208, a poor link condition is detected, at 210 the subscriber device 100 switches to the secondary codec rate, and at 212 uses the secondary codec rate to encode the voice signal into voice packets. Particularly, at 210 the controller 14 controls the codec 16 to encode the voice signal at the second bit-rate upon receiving a signal indicative of the occurrence of the predetermined triggering event (poor link condition) from the WLAN subsystem 18. Preferably, here the WLAN subsystem 18 sends an indication of the switch from primary codec rate to secondary codec rate to the receiving party.

During the poor link condition, a predetermined number of packets may be unsuccessfully transmitted or a particular packet may have to be retransmitted a number of times. However, the WLAN subsystem 18 may be unable to determine if one or more packets were unsuccessfully transmitted or the exact number of unsuccessfully transmitted packets. Therefore, the controller 14 may control the codec 16 to generate a redundancy packet including redundancies, which are one or more voice signals that were previously encoded, as well as the current voice signal. Generating the redundancy packet at the secondary bit-rate enables the redundancy packet to have a packet length substantially equal to a packet length of each of the packets encoded at the first bit-rate. That is, because the redundancy packet is generated at the second bit-rate, the packet can include a voice signal that was attempted to be transmitted in previous packets as well as the current voice signal, and still have a bit length substantially equal to a bit length of each of the packets encoded at the first bit-rate. The voice signal encoded at the second bit-rate into voice packets is transmitted to the WAP by the WLAN subsystem 18. Preferably, here the WLAN subsystem 18 sends an indication of use of the redundancy packet, as well as the switch from primary codec rate to secondary codec rate, to the receiving party.

At 214, the subscriber device 100 determines if the poor link condition has ended by, for example, the controller 14 detecting a signal from the WLAN subsystem 18 indicative of an end of the poor link condition. If, at 214, the end of the poor link condition is detected, the routine returns to 206, and the subscriber device 100 returns to using the primary codec rate for encoding the voice signal. If, at 214, the end of the poor link condition is not detected, the routine returns to 212, and the subscriber device 100 continues to use the secondary codec rate to encode the voice signal into voice packets. The routine will end when the connection is terminated.

As discussed above, the subscriber device 100 generally uses a primary codec rate and a secondary codec rate. The codec 16 may be implemented by a Global System for Mobile Communications (GSM) narrow band/wide band adaptive multi-rate (AMR) codec. An AMR codec has the advantage of an incorporated ability to dynamically change the bit-rate. This feature is useful for cellular networks, but it is not effective on its own in VoIP networks because the protocol headers typically tend to dominate the overall packet size. That is, solely changing the AMR bit-rate does not result in significant savings in the overall packet size. However, the reduced space can be used to carry redundancy (voice signal from one or more previously encoded voice packets). For example, an AMR codec can be run at a maximum bit-rate of 12.2 kbps as the primary codec during normal transmissions to encode a voice interval of 20 ms. During a poor link condition, the AMR codec can be run at a minimum rate of 4.75 kbps as the secondary codec. The max bit-rate can encode the 20 ms voice sample into a 31 byte packet. Encoding at the minimum bit-rate will provide approximately 136 bits available for redundancy. In this example, the voice signal previously encoded into up to two voice packets at the first bit-rate of 12.2 kbps, can be encoded within the redundancy packet at the second bit-rate of 4.75 kbps. Further, an FEC technique could be used for the available bits.

The codec 16 may also be implemented by the G711 codec as the primary codec and a G729 codec as the secondary codec. That is, the codec 16 may include G711 encoding for providing the first bit-rate during normal transmissions and G729 encoding for providing the second bit-rate upon the occurrence of the predetermined triggering event. In such a case, the controller 14 controls the primary G711 codec to encode the voice signal at the first bit-rate (as the primary codec rate) during normal transmissions and controls the secondary G729 codec to encode the voice signal at the second bit-rate (as the secondary codec rate) upon occurrence of the predetermined triggering event. The G711 codec is commonly used in networks and has the largest payload size. The G729 codec is also commonly used, and can be packed at a ratio of four G729 samples per G711 sample. When the controller 14 uses the G729 codec to encode the voice samples during the poor link condition, a voice packet may include 20 ms of current voice signal encoded by the G729 codec, and up to three redundancies, that is, up to three previously encoded voice packets (each also including 20 ms of voice signal). G726-xx may alternatively be used for the G729 codec.

The codec 16 may alternatively be implemented by the G711 codec as the primary codec and a redundancy G729 codec as the secondary codec. That is, the codec 16 will preferably have G711 encoding for providing the first bit-rate during the normal transmissions and redundancy G729 (RED G729) encoding as the second bit-rate upon the occurrence of the predetermined triggering event. RED is a payload type for a redundancy approach for VoIP that is disclosed in Request for Comments (RFC) 2198, the contents of which are incorporated by reference. During normal transmission, the controller 14 controls the codec 16 to encode the voice signal according to G711 encoding. Upon the occurrence of the predetermined triggering event, the controller 14 controls the codec 16 to encode the current voice signal according to G729 encoding, and to also include a number of redundancies, which are one or more voice packets that were previously encoded according to G729 encoding, along with a RED payload header. That is, the controller 14 controls the codec 16 to generate a redundancy packet comprised of the redundancies and the current voice signal all encoded at RED G729. RED G729 will only permit less than four G729 packets to be carried within the redundancy packet because the RED payload header introduces secondary four bytes of overhead.

The RED G729 encoding used as the secondary codec may further be modified to include FEC. Particularly, the redundancies in the redundancy packet can be encapsulated into FEC bits. Upon the occurrence of the predetermined triggering event, the controller 14 controls the codec 16 to encode the current voice signal according to RED G729 encoding, and to encapsulate at least a portion of the voice signal that was previously encoded in the FEC bits, which are encoded according to RED G729 as the second bit-rate. Use of FEC to encapsulate the redundancy should not change the baseline voice bandwidth. Therefore, FEC should not be a separate stream. This requirement is met by encapsulating the redundancy. In addition, an FEC code should be picked that spreads the FEC payload out as evenly as possible over the voice packets.

It should be noted that the codec 16 may be implemented by various combinations of primary codecs (of higher bit rate) and secondary codecs (of lower bit rate). As mentioned above, the G711 codec provides packets of 160 bytes at 20 ms. This is the largest codec (most bytes) and provides the best quality. Further, use of G711 as the primary codec provides numerous alternatives for the secondary codec, such as, for example, G729 as discussed above. When GSM AMR codec at full rate is used as the primary codec, the size of each of the packets is 31 bytes. In this case, the secondary codec is provided by switching the codec bit rate rather than switching to another codec (or codec encoding).

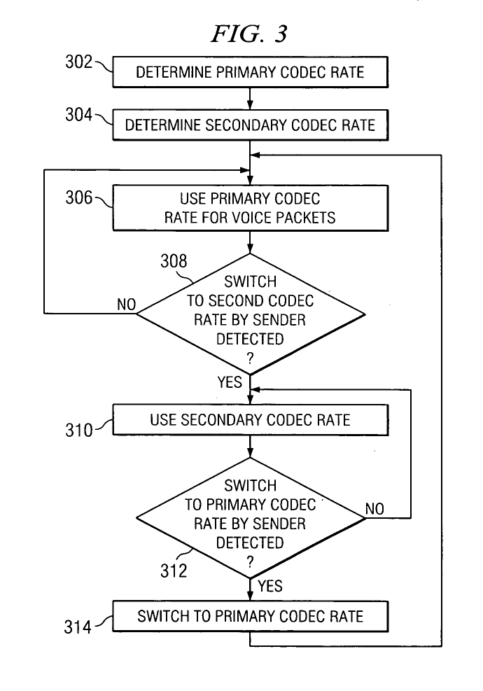

Referring to FIG. 3, an exemplary operation of the subscriber device 100 will be described in a scenario in which the subscriber device 100 is decoding RTP voice packets received over an IP based network from another subscriber device (sender) via a wireless connection with the 802.11 access point to reproduce a voice signal.

At 302-304, the subscriber device 100 determines the primary and secondary codec rates to be used for decoding the RTP voice packets into a voice signal. As discussed above, the secondary codec rate will be the second bit-rate, which is lower than the first bit-rate. Further, as discussed above, the primary and secondary codec rates are preferably determined during initial call negotiation.

After the initial call negotiation, at 306, the subscriber device 100 will use the primary codec rate for decoding the voice packets into voice signals (voice speech). Particularly, the controller 14 controls the codec 16 to decode the voice packets into the voice signals at the primary codec rate. The voice packets are received by the WLAN subsystem 18 from the WAP.

At 308, the subscriber device 100 determines if the transmitting subscriber device (sender) has switched from the primary codec rate to the secondary codec rate. Preferably, here the subscriber device 100 receives the indication sent from the sender indicative of the switch as discussed at 206 of FIG. 2.

If, at 308, no switch is detected, the routine returns to 306, and the subscriber device 100 continues to use the primary codec rate.

If, at 308, a switch is detected, then at 310 the subscriber device 100 switches to the secondary codec rate, which is used to decode the voice packets into voice signals. Particularly, at 310 the controller 14 controls the codec 16 to decode the voice packets into voice signal at the second bit-rate upon receiving a signal indicative of the switch from the sender.

After the switch, the sender may use different variations of the primary and secondary codec rate as discussed above. For example, the sender may use GSM narrow band/wide band AMR, G711 and G729, RED G729, RED with FEC, etc. Preferably, the sender will send an indication of the codec rates used along with, or subsequent to, the sending of the indication of the switch. The subscriber device 100 can accordingly use the corresponding codec device for decoding the voice packets. Here, the subscriber device 100 will also decode the redundancy packet which includes one or more redundancies encoded at the second bit-rate.

At 312, the subscriber device 100 determines if the sender has switched back to the primary codec rate from the secondary codec rate. Preferably, here also, the subscriber device 100 receives the indication sent from the sender indicative of the switch.

If, at 312, a switch is detected, then at 314 the subscriber device 100 switches back to the primary codec rate, and, at 306, uses the primary codec rate to decode the voice packets into voice signal. Particularly, at 314 the controller 14 controls the codec 16 to decode the voice packets into voice signal at the first bit-rate upon receiving a signal indicative of the switch from the sender.

If, at 312, no switch is detected, then at 310 the subscriber device 100 continues to use the secondary codec rate to decode the voice packets into voice signal.

The routine will end when the connection between the subscriber device 100 and the sender terminates.

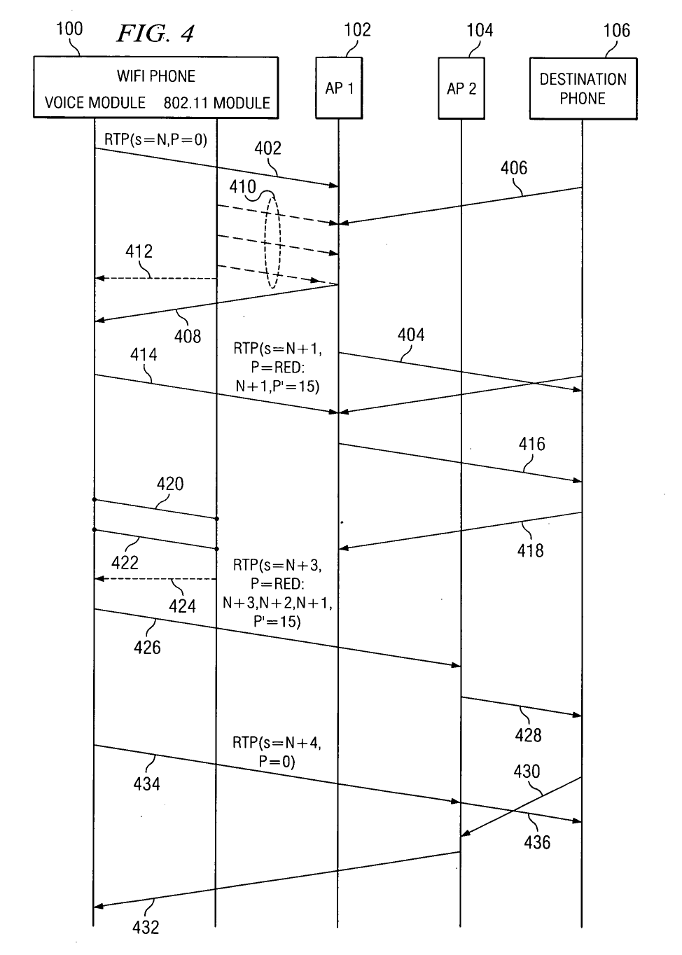

Referring to FIG. 4, an exemplary operation of the subscriber device 100 will be described in a scenario in which a subscriber device 100 is a WiFi phone in communication with a destination phone 106 over an IP-based network via a wireless connection with 802.11 access points (AP1, AP2) 102, 104. The access points AP1, AP2 may be within a Local Area Network. In this example, the codec 16 of the WiFi phone 100 uses G711 codec as the primary codec and RED G729 codec as the secondary codec. The WLAN subsystem 18 corresponds to the 802.11 module, and the host application 10 and the digital signal processor 12 correspond to the voice module.

At 402, the voice module of the WiFi phone 100 encodes a voice signal into an RTP voice packet RTP (s=N, P=0) at the primary codec rate and the 802.11 module attempts to send the RTP voice packet to the AP1 102. s=N refers to the sequence number and P=0 refers to G711 codec. The RTP voice packet is initially unsuccessfully transmitted to the AP1 102, and, as indicated at 410, the 802.11 module attempts to retransmit the RTP voice packet (s=N, P=0) to the AP1 102 a number of times. Here, three retransmission attempts are shown; however, the number of retransmissions is not limited to three. At 404, the AP1 102 receives the RTP voice packet (s=N, P=0), and sends it to the destination phone 106. The destination phone 106 decodes the RTP voice packet into a voice signal at the primary codec rate. At 406, the destination phone 106 also encodes a voice signal into a RTP voice packet, which is received at the AP1 102. At 408, the AP1 102 sends the RTP voice packet to the subscriber device 100, which decodes the RTP voice packet according to the primary codec rate.

The three attempts to transmit the RTP voice packet(s=N, P=0) by the 802.11 module at 410, is a triggering event that causes, at 412, the 802.11 module to instruct the voice module to switch from the G711 codec to the RED G729 codec. The three unsuccessful packet transmissions may be due to the RSSI falling below a predetermined RSSI level, the WLAN subsystem missing a beacon from the access point, or other reasons as discussed above.

At 414, the voice module (codec 12) encodes the voice signal of sequence N+1 according to RED G729 codec as the secondary codec rate into RTP voice packet RTP (s=N+1, P=RED: N+1, P′=15). P=RED refers to redundancy. P′=15 refers to G729. The 802.11 module of the WiFi phone 100 sends the RTP voice packet (s=N+1, P=RED: N+1, P′=15) to the AP1 102, which sends the voice packet to the destination phone at 416. Afterwards, the subscriber device 100 begins to roam to AP2 104.

At 416, the destination phone 106 receives the voice packet(s=N+1, P=RED: N+1, P′=15) with RED payload. Receipt of this voice packet serves as an indication to the destination phone 106 that the WiFi phone 100 has switched from the primary codec rate to RED G729 as the secondary codec rate. At 418, the destination phone 106 sends an acknowledgement of the switch that is received at the AP1 102.

At 420-422, successive voice packets (N+2, N+3) are dropped because the WiFi phone 100 is roaming from AP1 102 to AP2 104. At 424, the 802.11 module sends an indication that the roaming condition has ended to the voice module. The voice module (codec 12) then generates an RTP packet that includes the two previously dropped voice packets (N+2, N+3) and the voice packet (N+1) that was retransmitted three times. That is, the previously transmitted voice packets (N+3, N+2, N+1), or redundancies, are encoded according to the RED G729 encoding into RTP packet RTP(s=N+3, P=RED: N+3, N+2, N+1, P′=15) and transmitted to the AP2 104. At 428, the AP2 104 transmits the RTP packet RTP(s=N+3, P=RED: N+3, N+2, N+1, P′=15) to the destination phone 106, where it is decoded according to RED G729. The RTP packet also includes an indication that the WiFi phone 100 will be switching back to the primary rate codec. At 430, the destination phone 106 switches back to the primary rate codec (G71 1) and sends an acknowledgement to the AP2 104. At 432, the acknowledgement is sent from the AP2 104 to the subscriber device 100.

At 434, the voice module (codec 12) encodes the voice signal of sequence N+4 according to G711 codec as the primary codec rate into RTP voice packet RTP (s=N+4, P=0) and sends it to the AP2 104. At 436, the AP2 104 transmits the RTP packet to the destination phone 106, where it is decoded according to G711 decoding.

Although FIGS. 2-4 were various examples in which a voice signal is encoded into voice packets and voice packets are decoded into a voice signal, the routines are also applicable for the subscriber device 100 encoding and decoding data.

Therefore, the subscriber device 100 can provide redundancy during poor link/roaming conditions by defining an internal signaling path between lower level 802.11 software such as the WLAN subsystem 18 and upper layer voice software such as the controller 14 to communicate changes in the link quality. By selectively enabling the redundancy only when needed, and by using a redundancy technique that does not affect the overall voice bit rate, negative feedback can be prevented and operability within networks requiring admission control or bandwidth reservation at initial call negotiation is ensured. Further, when the subscriber device 100 is used on a Voice over Wireless local area network, the power requirements are not increased, and, in fact, may actually be lowered because requirements for rapid scanning to update a scan table may not be needed due to the increase in a permissible time in a roaming condition provided by the redundancies.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A subscriber device capable of Voice over Internet Protocol (VoIP) communication via a wireless connection with an 802.11 access point to an Internet Protocol (IP) based network, comprising:
a codec for encoding a voice signal into a Real Time Protocol (RTP) packet; and
a controller for controlling a bit-rate at which the codec encodes the voice signal so that the codec encodes the voice signal at a first bit-rate during normal transmissions and encodes the voice signal at a second bit-rate lower than the first bit-rate upon occurrence of a predetermined triggering event.

2. The subscriber device of claim 1, wherein the predetermined triggering event includes one of a received signal strength indication (RSSI) falling below a predetermined RSSI level, a beacon from the access point being missed, and a predetermined number of unsuccessful transmissions of the RTP packet.

3. The subscriber device of claim 2, wherein the controller is further for controlling the codec to generate the RTP packet as a redundancy packet comprised of the voice signal encoded at the second bit-rate and a voice signal that was previously encoded, the redundancy packet having a packet length substantially equal to a packet length of the RTP packet encoded at the first bit-rate.

4. The subscriber device of claim 3, wherein the codec comprises a narrow band/wide band adaptive multi-rate codec.

5. The subscriber device of claim 1, wherein:
the codec is comprised of a primary G711 codec and a secondary G729 codec; and
the controller controls the primary G711 codec to encode the voice signal at the first bit-rate during normal transmissions and controls the secondary G729 codec to encode the voice signal at the second bit-rate upon the occurrence of the predetermined triggering event.

6. The subscriber device of claim 1, further comprising:
a wireless local area network (WLAN) subsystem for providing the wireless connection, wherein the controller controls the codec to encode the voice signal at the second bit-rate upon receiving a signal indicative of the occurrence of the predetermined triggering event from the WLAN subsystem.

7. The subscriber device of claim 6, wherein the predetermined triggering event includes one of a received signal strength indication (RSSI) falling below a predetermined RSSI level, the WLAN subsystem missing a beacon from the access point, and a predetermined number of retransmissions of the RTP packet by the WLAN subsystem.

8. The subscriber device of claim 6, wherein the controller controls the codec to encode the voice signal according to G711 encoding as the first bit-rate during the normal transmissions and controls the codec to encode the voice signal according to redundancy G729 encoding as the second bit-rate upon the occurrence of the predetermined triggering event.

9. The subscriber device of claim 6, wherein:
the controller controls the codec to encode the voice signal according to G711 encoding as the first bit-rate during the normal transmissions; and
the controller controls the codec to encode the voice signal according to G729 encoding as the second bit-rate and to encode voice signal from one or more previously transmitted RTP packets encapsulated within Forward Error Correction bits.

10. A method of providing Voice over Internet Protocol (VOIP) communication over a wireless communication link, comprising:
encoding a voice signal into packets at a first bit-rate during normal transmissions;
if poor link quality exists, detecting occurrence of a predetermined triggering event associated with poor link quality; and
encoding the voice signal into packets at a second bit-rate lower than the first bit-rate upon the detecting of the occurrence of the predetermined triggering event associated with the poor link quality.

11. The method of claim 10, wherein the detecting of the occurrence of the predetermined triggering event associated with the poor link quality further comprises detecting one of a received signal strength indication (RSSI) falling below a predetermined RSSI level, missing a beacon from an access point, and a predetermined number of packet retransmissions as the detecting of the occurrence of the predetermined triggering event associated with the poor link quality.

12. The method of claim 11, wherein the encoding of the voice signal into packets at the second bit-rate further comprises generating a redundancy packet comprised of a portion of voice signal that was previously encoded in one or more previous packet transmissions, the portion of the voice signal being encoded at the second bit-rate in the redundancy packet, wherein the redundancy packet has a bit length substantially equal to a bit length of each of the packets encoded at the first bit-rate.

13. The method of claim 12, wherein the generating of the redundancy packet further comprises generating the redundancy packet to include a RED payload header.

14. The method of claim 12, wherein the generating of the redundancy packet further comprises encapsulating the portion of the voice signal that was previously encoded into Forward Error Correction bits.

15. The method of claim 10, further comprising transmitting a primary codec rate and a secondary codec rate during initial call negotiation, wherein the primary codec rate defines the first bit-rate and the secondary codec rate defines the second bit-rate to be lower than the first bit-rate.

16. A subscriber device capable of Voice over Internet Protocol (VoIP) communication via a wireless connection with an 802.11 access point, comprising:
means for encoding a voice signal into packets; and
means for controlling a bit-rate at which the voice signal is encoded so that the voice signal is encoded into packets at a first bit-rate during normal transmissions and, upon occurrence of a predetermined triggering event, encoded at a second bit-rate lower than the first bit-rate into a redundancy packet comprised of a portion of voice signal that was previously encoded, the redundancy packet having a packet length substantially equal to a packet length of each of the packets encoded at the first bit-rate.

17. The subscriber device of claim 16, wherein the predetermined triggering includes one of a received signal strength indication (RSSI) falling below a predetermined RSSI level, a beacon from the access point being missed, and unsuccessfully transmitting a packet a predetermined number of times.

18. The subscriber device of claim 16, wherein the redundancy packet is further comprised of the previously encoded voice signal encapsulated within Forward Error Correction bits.

19. A Voice over Internet Protocol (VoIP) network comprising:
one or more access points configured according to the Institute of Electrical and Electronic Engineers (IEEE) 802.11 standard, the one or more access points having a connection to an Internet Protocol (IP) based network;
a subscriber device for performing wireless communication via a connection with at least one of the one or more access points, wherein the subscriber device comprises:
a codec for encoding a voice signal; and
a controller for controlling a bit-rate at which the codec encodes the voice signal so that the codec encodes the voice signal at a first bit-rate during normal transmissions into a real time transport (RTP) packet, and, upon occurrence of a predetermined triggering event, encodes voice signal at a second bit-rate lower than the first bit-rate into a redundancy packet, the redundancy packet comprising the voice signal encoded at the second bit-rate and voice signal that was previously encoded, the redundancy packet having a packet length substantially equal to a packet length of the RTP packet encoded at the first bit-rate.
